(19) United States
(12) Patent Application Publication
(10) Pub. No.: US 2015/0356513 A1
(43) Pub. Date: Dec. 10, 2015

(54) SYSTEMS AND METHODS FOR INCENTIVIZING ACTIVITIES OF EMPLOYEES RESULTING IN REDUCED HEALTHCARE SPENDING

(71) Applicants: Nathan R. Walkingshaw, Salt Lake City, UT (US); Chris Mayfield, Salt Lake City, UT (US)

(72) Inventors: Nathan R. Walkingshaw, Salt Lake City, UT (US); Chris Mayfield, Salt Lake City, UT (US)

(21) Appl. No.: 14/707,267

(22) Filed: May 8, 2015

Related U.S. Application Data
(60) Provisional application No. 62/007,485, filed on Jun. 4, 2014.

(51) Int. Cl. G06Q 10/10

(52) U.S. Cl. CPC G06Q 10/1057

(57) ABSTRACT

Implementation of the invention provides systems and methods for incentivizing wide-scale employee behavioral changes that can lead to improved employee wellbeing and concomitant decreases in healthcare costs for employers and employees. The systems and methods may also lead to improved employee morale, increased productivity, and a variety of other benefits for both employees and employers

### CROSS-REFERENCE TO RELATED APPLICATIONS

This application claims the benefit of U.S. Provisional Patent Application No. 62/007,485 which was filed on Jun. 4, 2014.

### BACKGROUND OF THE INVENTION

1. Field of the Invention

The present invention relates to health and healthcare, and more particularly to systems and methods that allow employers to incentivize employees to have increased health and wellbeing, and to take actions that will reduce employers healthcare spending.

2. Background and Related Art

Many employers expend significant sums providing for the wellbeing and healthcare of their employees. Despite or, at time, because of healthcare reforms, the cost of providing healthcare to employees continues to rise at a pace that exceeds inflation. Meanwhile, despite efforts to encourage employees to be more healthful, many employees suffer from sickness or general ill-being. Such sickness or general ill-being leads to increased healthcare costs for employers, including but not limited to increased healthcare insurance premiums, and further leads to lost productivity and other costs. Systems and methods that lead to improved employee wellbeing are needed.

### BRIEF SUMMARY OF THE INVENTION

Implementation of the invention provides systems and methods for incentivizing wide-scale employee behavioral changes that can lead to improved employee wellbeing and concomitant decreases in healthcare costs for employers and employees. The systems and methods may also lead to improved employee morale, increased productivity, and a variety of other benefits for both employees and employers that will be discussed herein or will become apparent from practice of implementations of the invention. Implementation of the systems and methods described herein may involve or utilize computer systems, computer-readable media, including non-transitory computer-readable media, and computer-implemented method steps.

According to implementations of the invention, a computer-implemented method of incentivizing behavioral changes in employees, the behavioral changes leading to improved employee wellbeing and reduced insurance rates for an employer, may include a variety of computing-device-implemented steps. Such steps may include crediting a virtual account of each of a plurality of employees with a wellness credit at a start of a first time period, and maintaining or decreasing the value of each employee's wellness credit during the first time period. The maintenance or decreasing of the wellness credit may include repeated steps of notifying each of the plurality of employees of his or her current wellness credit, receiving inputs during a portion of the first time period relating to wellbeing of each of the plurality of employees, and utilizing the inputs relating to wellbeing of each of the plurality of employees to perform an action.

The action performed may include a variety of actions such as maintaining a current value of that employee's wellness credit, and deducting an amount from that employee's wellness credit. At the end of the first period, each employee's final wellness credit for the first time period may be reported. At the end of a second time period (which may be equal to or longer than the first time period, each employee is presented with the sum of all final wellness credits for that employee during the second time period.

The value of each employee's wellness credit may be tracked and available in real time. An initial value of each employee's wellness credit may correspond to an estimated value to the employer of improved wellbeing of the employees. For example, an initial value of each employee's wellness credit may correspond to an estimated reduction in healthcare costs that the employer could realize during the first time period if the plurality of employees all had an ideal wellbeing.

Maintaining or decreasing the value of each employee's wellness credit may further include an additional step of notifying a representative of the employer of information related to employees' wellbeing. A variety of information may be provided to the employer representative, including current values of employees' wellness credits, a current sum of the values of all employees' wellness credits, a current sum of the values of a selected portion of employee's wellness credits, a current report of inputs received relating to wellbeing of the plurality of employees, information relating to employees' current health status, information relating to improvements in employees' health status, information relating to employees' current financial status, information relating to improvements in employee's financial status, information relating to employees' current activity level, information relating to improvements in employees' activity level, information relating to employees' responses to wellbeing challenges, information relating to employees' participation in a wellbeing incentivizing program, and any other information relative to employees' wellness and/or changes in employees' wellness. The employer representative may use the information to implement or modify campaigns to improve employees' wellbeing.

Receiving inputs during a portion of the first time period relating to wellbeing of each of the plurality of employees may include receiving inputs from one or more wearable or implantable devices configured to monitor information related to physical wellness of one or more of the plurality of employees. The one or more wearable or implantable devices may include devices such as a heart rate monitor, a global positioning system (GPS) device, a fitness tracking device, a pedometer, a sleep quality monitor, a calories burned monitor and/or calculator, a blood oximeter, and a glucose meter. Regardless of the specific device, the inputs received from the one or more wearable or implantable devices may be received in real time. Additionally, the inputs received from the one or more wearable or implantable devices may be aggregated and provided to the employer or its representative in real time to facilitate the employer's real-time efforts to improve employee wellbeing.

Implementations of the invention may provide a method of incentivizing behavioral changes in employees, the behavioral changes leading to improved employee wellbeing and reduced insurance rates for an employer. The method may include computing-device-implemented steps of crediting a virtual account of each of a plurality of employees with a wellness credit at a start of a first time period and maintaining or decreasing the value of each employee's wellness credit during the first time period. The step of maintaining or decreasing the value of a wellness credit may include repeated steps of notifying each of the plurality of employees of his or her current wellness credit, receiving inputs during a portion of the first time period relating to wellbeing of each of the plurality of employees, utilizing the inputs relating to wellbeing of each of the plurality of employees to perform an action such as maintaining a current value of that employee's wellness credit and deducting an amount from that employee's wellness credit, notifying a representative of the employer of information related to employees' wellbeing, and receiving input from the representative of the employer to modify one or more aspects of a campaign to improve employees' wellbeing based on the inputs received from the employees related to the employees' wellbeing. At the end of the first time period, each employee's final wellness credit for the first time period is reported, and at the end of a second time period, each employee is provided with the sum of all final wellness credits for that employee during the second time period.

Maintaining or decreasing the value of each employee's wellness credit during the first time period may also include additional repeated steps of receiving input from the representative of the employer configured to issue a wellbeing challenge to one or more of the plurality of employees, outputting the wellbeing challenge to the one or more of the plurality of employees, and receiving inputs from employees relating to completion or partial completion of the wellbeing challenge. Additionally or alternatively, maintaining or decreasing the value of each employee's wellness credit during the first time period further comprises additional repeated steps of receiving input from the representative of the employer configured to issue a wellbeing question to one or more of the plurality of employees, outputting the wellbeing question to the one or more of the plurality of employees, and receiving inputs from employees including responses the wellbeing question.

In respect of privacy concerns relating to employee wellness, implementations of the invention embrace the anonymizing of information and data received from employees prior to reporting or presentation of data to the employer or the employer's representative. Some or all employee data and information may be anonymized prior to being made available to the employer or its representative.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a representative computing environment for use with embodiments of the invention;

FIG. 2 shows a representative networked computing environment for use with embodiments of the invention;

FIG. 3 shows a representative browser window;

FIGS. 4-5 show flowcharts of methods in accordance with embodiments of the invention; and

FIGS. 6-13 show representative screenshots illustrating features of embodiments of the invention.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention provides systems and methods for incentivizing wide-scale employee behavioral changes that can lead to improved employee wellbeing and concomitant decreases in healthcare costs for employers and employees. The systems and methods may also lead to improved employee morale, increased productivity, and a variety of other benefits for both employees and employers that will be discussed herein or will become apparent from practice of embodiments of the invention. Embodiments of the systems and methods described herein may involve or utilize computer systems, computer-readable media, including non-transitory computer-readable media, and computer-implemented method steps.

According to embodiments of the invention, a computer-implemented method of incentivizing behavioral changes in employees, the behavioral changes leading to improved employee wellbeing and reduced insurance rates for an employer, may include a variety of computing-device-implemented steps. Such steps may include crediting a virtual account of each of a plurality of employees with a wellness credit at a start of a first time period, and maintaining or decreasing the value of each employee's wellness credit during the first time period. The maintenance or decreasing of the wellness credit may include repeated steps of notifying each of the plurality of employees of his or her current wellness credit, receiving inputs during a portion of the first time period relating to wellbeing of each of the plurality of employees, and utilizing the inputs relating to wellbeing of each of the plurality of employees to perform an action.

The action performed may include a variety of actions such as maintaining a current value of that employee's wellness credit, and deducting an amount from that employee's wellness credit. At the end of the first period, each employee's final wellness credit for the first time period may be reported. At the end of a second time period (which may be equal to or longer than the first time period, each employee is presented with the sum of all final wellness credits for that employee during the second time period.

The value of each employee's wellness credit may be tracked and available in real time. An initial value of each employee's wellness credit may correspond to an estimated value to the employer of improved wellbeing of the employees. For example, an initial value of each employee's wellness credit may correspond to an estimated reduction in healthcare costs that the employer could realize during the first time period if the plurality of employees all had an ideal wellbeing.

Maintaining or decreasing the value of each employee's wellness credit may further include an additional step of notifying a representative of the employer of information related to employees' wellbeing. A variety of information may be provided to the employer representative, including current values of employees' wellness credits, a current sum of the values of all employees' wellness credits, a current sum of the values of a selected portion of employee's wellness credits, a current report of inputs received relating to wellbeing of the plurality of employees, information relating to employees' current health status, information relating to improvements in employees' health status, information relating to employees' current financial status, information relating to improvements in employee's financial status, information relating to employees' current activity level, information relating to improvements in employees' activity level, information relating to employees' responses to wellbeing challenges, information relating to employees' participation in a wellbeing incentivizing program, and any other information relative to employees' wellness and/or changes in employees' wellness. The employer representative may use the information to implement or modify campaigns to improve employees' wellbeing.

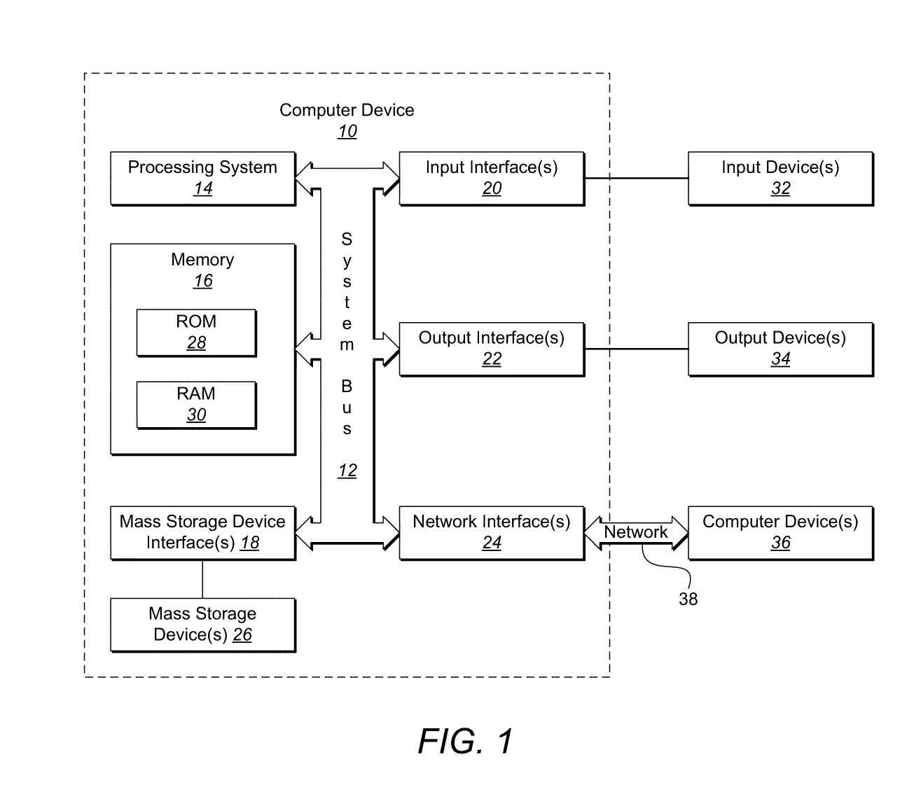

As embodiments of the invention may be implemented using a variety of computing systems and computer devices, FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand-alone electronic devices, and other such electronic environments.

Receiving inputs during a portion of the first time period relating to wellbeing of each of the plurality of employees may include receiving inputs from one or more wearable or implantable devices configured to monitor information related to physical wellness of one or more of the plurality of employees. The one or more wearable or implantable devices may include devices such as a heart rate monitor, a global positioning system (GPS) device, a fitness tracking device, a pedometer, a sleep quality monitor, a calories burned monitor and/or calculator, a blood oximeter, and a glucose meter. Regardless of the specific device, the inputs received from the one or more wearable or implantable devices may be received in real time. Additionally, the inputs received from the one or more wearable or implantable devices may be aggregated and provided to the employer or its representative in real time to facilitate the employer's real-time efforts to improve employee wellbeing.

Embodiments of the invention may provide a method of incentivizing behavioral changes in employees, the behavioral changes leading to improved employee wellbeing and reduced insurance rates for an employer. The method may include computing-device-implemented steps of crediting a virtual account of each of a plurality of employees with a wellness credit at a start of a first time period and maintaining or decreasing the value of each employee's wellness credit during the first time period. The step of maintaining or decreasing the value of a wellness credit may include repeated steps of notifying each of the plurality of employees of his or her current wellness credit, receiving inputs during a portion of the first time period relating to wellbeing of each of the plurality of employees, utilizing the inputs relating to wellbeing of each of the plurality of employees to perform an action such as maintaining a current value of that employee's wellness credit and deducting an amount from that employee's wellness credit, notifying a representative of the employer of information related to employees' wellbeing, and receiving input from the representative of the employer to modify one or more aspects of a campaign to improve employees' wellbeing based on the inputs received from the employees related to the employees' wellbeing. At the end of the first time period, each employee's final wellness credit for the first time period is reported, and at the end of a second time period, each employee is provided with the sum of all final wellness credits for that employee during the second time period.

Maintaining or decreasing the value of each employee's wellness credit during the first time period may also include additional repeated steps of receiving input from the representative of the employer configured to issue a wellbeing challenge to one or more of the plurality of employees, outputting the wellbeing challenge to the one or more of the plurality of employees, and receiving inputs from employees relating to completion or partial completion of the wellbeing challenge. Additionally or alternatively, maintaining or decreasing the value of each employee's wellness credit during the first time period further comprises additional repeated steps of receiving input from the representative of the employer configured to issue a wellbeing question to one or more of the plurality of employees, outputting the wellbeing question to the one or more of the plurality of employees, and receiving inputs from employees including responses the wellbeing question.

In respect of privacy concerns relating to employee wellness, embodiments of the invention embrace the anonymizing of information and data received from employees prior to reporting or presentation of data to the employer or the employer's representative. Some or all employee data and information may be anonymized prior to being made available to the employer or its representative.

Embodiments of the present invention embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

With reference to FIG. 1, a representative system for implementing embodiments of the invention includes computer device 10, which may be a general-purpose or special-purpose computer or any of a variety of consumer electronic devices. For example, computer device 10 may be a personal computer, a notebook or laptop computer, a netbook, a personal digital assistant (“PDA”) or other hand-held device, a smart phone, a tablet computer, a workstation, a minicomputer, a mainframe, a supercomputer, a multi-processor system, a network computer, a processor-based consumer electronic device, a computer device integrated into another device or vehicle, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer-readable media, such as on memory 16, a magnetic hard disk, a removable magnetic disk, a magnetic cassette, an optical disk, or from a communication connection, which may also be viewed as a computer-readable medium.

Memory 16 includes one or more computer-readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer-readable medium. Mass storage devices 26 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

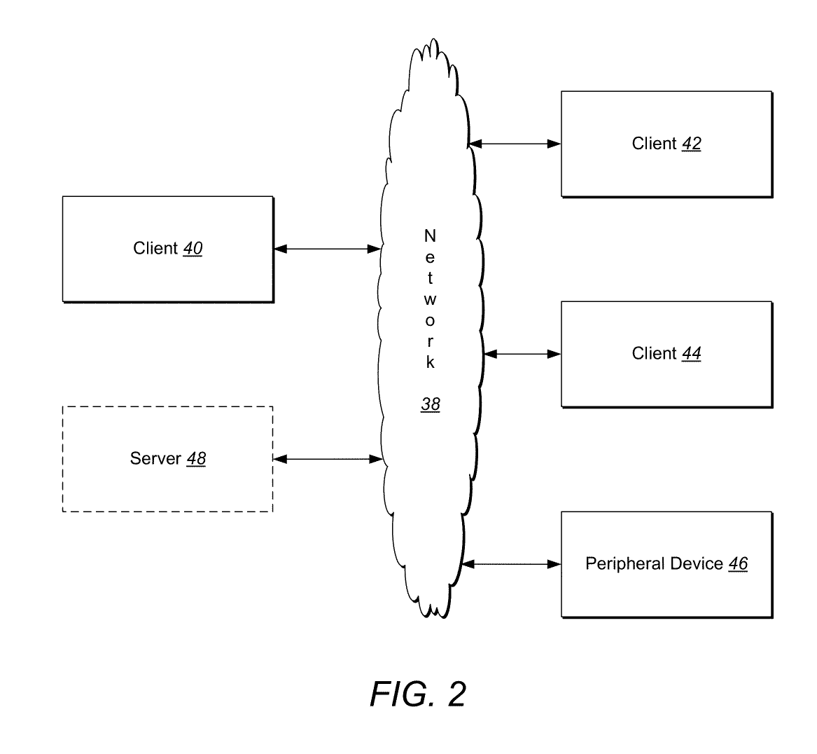

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices 46 across network 38. While FIG. 2 illustrates an embodiment that includes a client 40, two additional clients, client 42 and client 44, one peripheral device 46, and optionally a server 48, connected to network 38, alternative embodiments include more or fewer clients, more than one peripheral device, no peripheral devices 46, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

Similarly, embodiments of the invention embrace cloud-based architectures where one or more computer functions are performed by remote computer systems and devices at the request of a local computer device. Thus, returning to FIG. 2, the client 40 may be a computer device having a limited set of hardware and/or software resources. Because the client 40 is connected to the network 38, it may be able to access hardware and/or software resources provided across the network 38 by other computer devices and resources, such as client 42, client 44, server 48, or any other resources. The client 40 may access these resources through an access program, such as a web browser, and the results of any computer functions or resources may be delivered through the access program to the user of the client 40. In such configurations, the client 40 may be any type of computer device or electronic device discussed above or known to the world of cloud computing, including traditional desktop and laptop computers, smart phones and other smart devices, tablet computers, or any other device able to provide access to remote computing resources through an access program such as a browser.

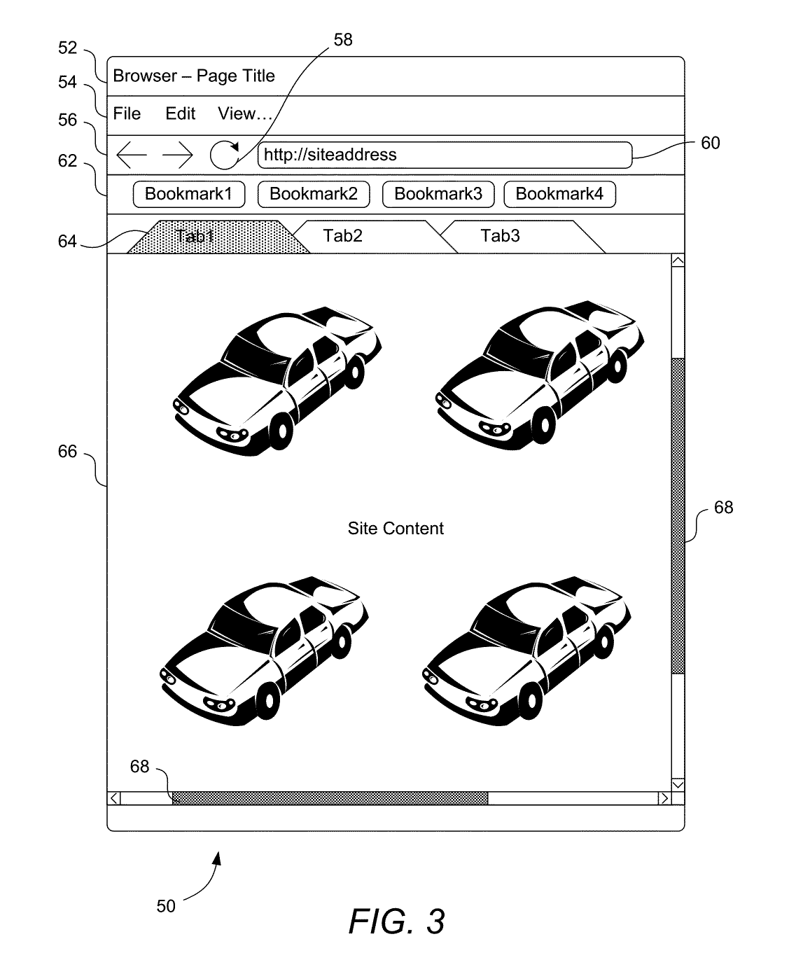

To minimize the need to download and/or install programs on users' computers, embodiments of the invention utilize existing web browser technology. Many browser programs currently exist or are under development, and it would be impossible to name all such browser programs, but examples of such programs include Microsoft's Internet Explorer, Mozilla Firefox, Google Chrome, Apple Safari, Opera Software's Opera browser, as well as myriad browsers specifically configured for specific devices, such as Internet-connected smart phones and the like. While the exact display of each browser can vary from browser to browser and while most are moderately to highly configurable so as to vary the exact display, FIG. 3 shows a representative browser window 50 similar to what might be displayed on a user's computer device. It will be appreciated that many of the features described below with respect to the illustrated browser window 50 are optional or are optionally displayed or hidden as desired by the user, but each feature is typical or illustrative of features common to many browser programs.

The browser window 50 of FIG. 3 includes a title bar 52. The title bar 52 often is used to display a page name of whatever page is actively being viewed. Most commonly, the page name that is displayed is selected by the administrator of the website being viewed, and the page name often includes one or more phrases associated with the administrator of the website and/or the page being viewed. The browser window 50 also includes a menu bar 54 that includes items that may be selected to provide access to various menu functions, as is well known in the art. Of course, the menu functions provided in the menu bar 54 may vary according to the specific browser program, among other considerations, and access to menu functions may be provide other than by a menu bar similar to menu bar 54.

The browser window 50 of FIG. 3 also includes an address bar 56, which in the browser window 50 shown in FIG. 3 includes several browser controls 58 and an address entry area 60. The browser controls 58 and the address entry area 60 facilitate browsing using the window, permitting the user, for example, to go back one or more pages, to go forward one or more pages, to refresh a page, and/or to type in a destination site's address to directly access a page. Such browser features are well known in the art and need not be further discussed.

The browser window 50 also includes a bookmark bar 62 that a user can populate with bookmarks to commonly-accessed web pages, such that the user can quickly re-access the page(s) by clicking on the relevant bookmark button. In most common browser programs, it is possible for the user to have several different websites open simultaneously, and for the browser to provide rapid access, switching between, and management of the various open sites by way of various tabs 64, as shown in FIG. 3. Each tab 64 provides access to one open website. The tabs 64 facilitate navigation between different open websites. The contents of each open and actively-viewed website may be displayed in a content area 66. Thus, the content displayed in the content area 66 may vary depending on which tab 64 is selected, and which website is being viewed.

Whereas the tabs facilitate navigating between different websites, the browser window 50 optionally includes features to facilitate navigating within a website, as is known in the art. Specifically, the browser window may optionally include one or more scroll bars 68. When a portion of the website being viewed lies outside of the viewable portion of the content area 66, the user may use the scroll bars 68 to access non-visible portions, as is known in the art.

Many currently-available browser programs permit the installation of additional features, such as through what are commonly known as “browser extensions.” Browser extensions are becoming more and more common in today's browser programs, and have become one of if not the standard for extending the functionality of the browser programs. For browsers that do not currently support browser extensions, other mechanisms and installed programs are often available to provide similar functionality.

Embodiments of the invention may utilize a browser extension or similar format to provide functions in accordance with embodiments of the invention. The use and installation of a browser extension is typically significantly less involved and less computer-intensive than the use and installation of a stand-alone program. In many instances, the installation of the browser extension occurs essentially without the computer's operating system being made aware of any additional installation. Instead, the browser program itself handles the browser extension and any demands made by the browser extension. A browser extension in accordance with embodiments of the invention, for example, may be rapidly and easily installed, such as by visiting a download website.

As discussed above, many employers expend significant sums providing for the wellbeing and healthcare of their employees. Direct expenditures and costs may include those associated providing health insurance and other health benefits. Indirect expenditures and costs may include lost productivity, increased training costs of new employees to replace lost employees, and other indirect expenditures and costs resulting from poor employee wellbeing and/or morale. Embodiments of the invention allow employers to address both direct and indirect expenditures and costs by improving employees' wellbeing through computer-assisted systems and methods for improving.

The systems and methods may address various aspects of employees' well-being. By way of non-limiting example, systems and methods in accordance with embodiments of the invention may be designed and implemented to track and motivate change in five areas of employee wellbeing. One such area is the employees' career wellbeing. A second such area is the employees' financial wellbeing. A third such area is employees' social wellbeing. A fourth such area is employees' nutritional wellbeing. A fifth such area is employees' physical/activity wellbeing. While embodiments of the invention embrace the tracking and motivation of change in five areas of wellbeing, and specifically the five areas discussed above, other embodiments of the invention may track and motivate change in fewer than five areas (e.g. either a subset of the areas discussed above or where one or more of the areas discussed above is combined with another area, such as by combining nutritional wellbeing with physical/activity wellbeing). Still other embodiments of the invention involve the tracking and motivation of change in more than five areas (e.g. either by addition of additional areas not discussed above or by dividing one or more of the areas of wellbeing discussed above into multiple areas of wellbeing).

The selected areas of wellbeing to track and in which to motivate change may be selected and/or changed by the employer at any time. For example, the employer may initially believe that improvement in employees' wellbeing may be especially necessary in certain areas. Thereafter, after using embodiments of the invention for a period of time, sufficient progress may have been made in certain areas to begin focusing on improvements in one or more other areas. As an additional example, an employer might elect to begin a wellbeing improvement program in a single area at first, and could elect to add additional areas over time as employees become used to the functions of the system and the improvements in wellbeing realized. For all these reasons, the specific embodiments illustrated herein should be deemed illustrative of the features and characteristics of embodiments of the invention, and should not be viewed as limiting on the scope of the invention defined by the claims appended hereto.

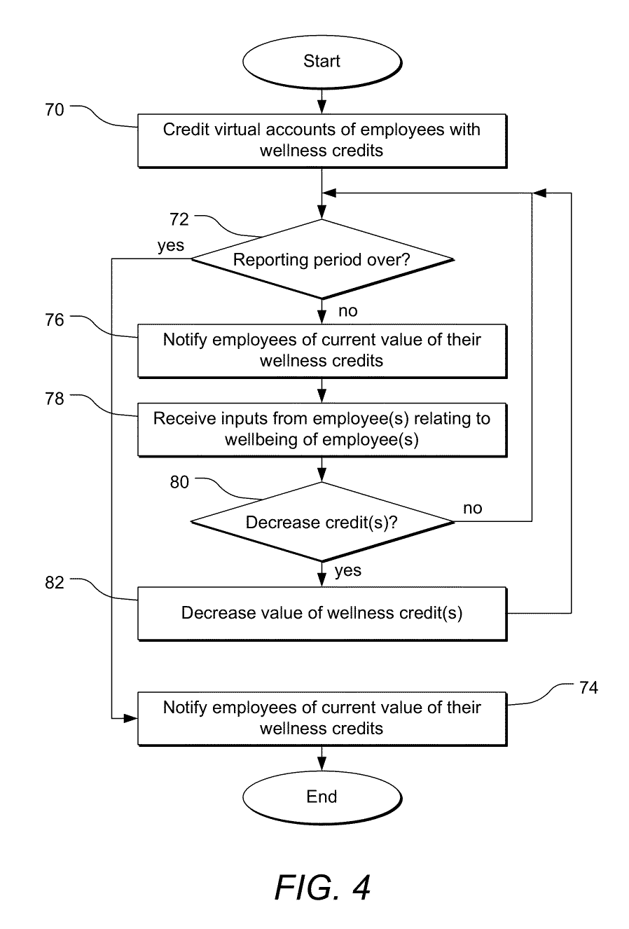

A method in accordance with embodiments of the invention is illustrated in the flowchart of FIG. 4. The method illustrated in FIG. 4 is one that occurs over a first time period selected by the employer. The time period may be a relatively short one, such as a time period of one day or a few days or some other relatively short time period, such as a week or a few weeks. The method of FIG. 4 may be repeated one or more times over a longer time period, such as a few days or a week (if the first time period is a day) or a few weeks, a month, or months (if the first time period is a week or a few weeks). Generally, the second time period is an integer multiple (e.g. one times, two times, three times, four times) of the first time period.

The method begins with step 70, in which the system credits virtual accounts of one or more employees with wellness credits. The wellness credits may be any credit desired and selected to motivate the employees. By way of example, the wellness credit may be a dollar amount, a credit of time (e.g. paid time off), a credit toward a prize, or any other credit.

In some examples, the credit is a monetary credit selected by the employer. The monetary credit may correspond to an estimated value to the employer of improved wellbeing of the employee(s). For example, if employees wellbeing were to improve, the employer may estimate that it could save a certain amount per employee in healthcare costs, such as reduced insurance premiums. Additionally, the employer might estimate that improved employee wellbeing in one or more areas would lead to improved productivity and reduced sick days. The employer could evaluate and consider any or all aspects of value that it expects it could receive based on a desired improvement to employee wellbeing and could assign a monetary value to that improvement and then determine an amount of that monetary value that it will commit to the wellbeing improvement program.

For example, an employer might determine in consultation with its insurance provider that it could save a certain amount of money per year in health insurance premiums if certain changes were to be realized in its employee workforce, such as a 15% reduction in body mass index (BMI), a 30% reduction in employee smoking, a 15% reduction in the number of employees with high cholesterol and/or high blood pressure, and/or any other selected health changes. Alternatively or additionally, the employer might estimate that it could realize a 5% increase in profits from improved employee productivity/morale relating to certain wellbeing changes. The employer could determine the total value it estimates it could realize as a result of targeted wellbeing changes over a period of time, such as over a month, a few months, a year, or a few years, and could determine a dollar amount corresponding to such changes. The employer could then commit a reward amount to the wellbeing program accordingly. Some employers might commit a reward amount that is somewhat smaller than the estimated total value, while others could commit the full amount of the estimated total value, while still others might commit more than the estimated total value.

The employer's monetary commitment might change over time. For example, if an employer begins to realize greater profits than initially expected from improved productivity and/or fewer losses than expected from employee sick days as a result of the wellbeing program, the employer could commit additional funds as rewards to the wellbeing program. As another example, if the employees respond to the wellbeing program well enough to establish that they are beginning to be self-motivated to behaviors leading to improved wellbeing, the employer might choose to gradually reduce the funds dedicated to the wellbeing program. Changes to the amounts committed as rewards to the wellbeing program may be modified based on actual and perceived benefits considerations relating to the employees and/or to the employer.

According to embodiments of the invention, when the employer commits a total reward value to the wellbeing program, that total amount is divided into smaller amounts corresponding to the total number of employees in the wellbeing program and the total number of reporting periods over which the total amount is to be spread. By way of a straightforward example only, the employer may commit to the wellbeing program for an entire year, or approximately two hundred fifty workdays (assuming the system rewards participation only on workdays). If the employer has one hundred employees, the total number of employee workdays over a year is twenty-five thousand. If the employer were to commit $266,250.00 to the wellbeing program, and were to divide that amount into employee workdays, the daily per-worker value of participation in the employee wellbeing program might be said to be $10.65. This amount could be used as the initial wellness credit credited to the virtual account of each employee in step 70 of FIG. 4. Of course, this example could be varied according to a wide variety of factors relating to individual employees and employers.

The employees' virtual accounts could be credited with the initial wellness credit at the start of each reporting period (e.g. day, each few days, each workday, each few workdays, each week, each workweek, etc.) for the wellness improvement program. At the end of each reporting period, whatever portion of the wellness credit that remains to the employee(s) will then or later be given to the employee(s). The remainder of the method of FIG. 4 illustrates how the process determines what portion of the employees' initial wellness credits is to be given to them.

Therefore, the process proceeds to decision block 72, where a determination is made as to whether the current reporting period is over. At the end of the process, when the reporting period ends, the employees are notified at step 74 as to what portion of the wellness credit remains to them. When the reporting period has not ended, the method proceeds to step 76, where the employees are notified as to what portion of their wellness credits remain to them. This step may be optional at times. For example, the employees may know what their wellness credits are at the start of each day, if the credit is the same each day. Thus, the step of notifying the employees may occur only at certain times, such as when there are changes in the wellness credits, or only upon request by the employees, as they track their efforts toward improved wellbeing.

The method then proceeds to step 78, where the system receives inputs from one or more employees relating to the wellbeing of the employees. The inputs received may be a variety of inputs, relating to any aspect of wellbeing being tracked by the employer and the system, such as relating to one of the five areas of wellbeing discussed above. The inputs may relate to current status of an area of wellbeing of the employee(s), and/or a change in status of an area of wellbeing of the employee(s). The inputs may be received by any of a variety of computer systems in real time, such as through a work computer system, a mobile computing device such as a cell phone or smart phone, a home computer system, a special-purpose computing device (e.g. an activity tracker worn by the employee(s)), and the like.

After the system receives one or more inputs from employee(s), the method continues to decision block 80, where a determination is made as to whether to decrease one or more wellness credits of one or more employees. The decision may be based upon a variety of factors, including employee participation or lack thereof in the wellness program, current status of employee(s), changes in status of employee(s), participation of employee(s) or lack thereof in sub-portions of the wellness program (as will be discussed in more detail below), responses of employee(s) or lack thereof to challenges issued by the system/employer, and the like. If no reduction in wellness credits is to occur, execution loops back to decision block 72 until the reporting period is over. If, however, a deduction is to occur, the value of the wellness credit is decreased at step 82, whereupon execution loops back to decision block 72 as described.

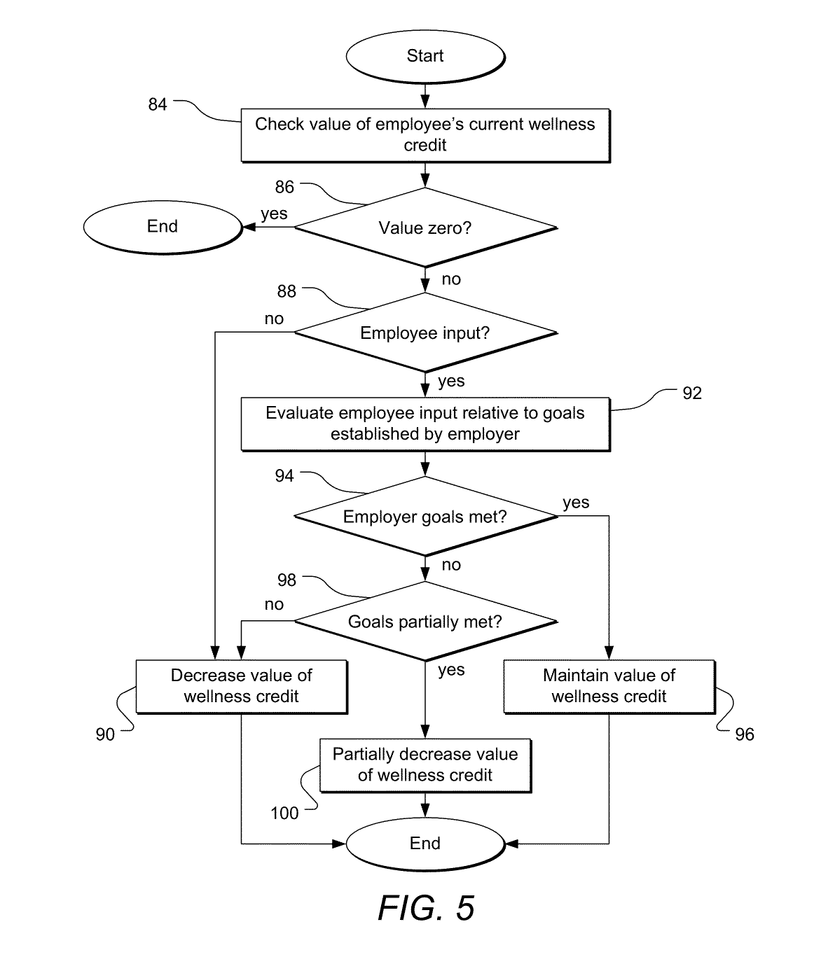

FIG. 5 illustrates an exemplary method for determining whether to decrease a wellness credit according to decision block 80 of FIG. 4. This method of FIG. 5 is illustrated with respect to the decision for a single employee, and may be repeated as necessary for all decisions for all employees. According to the method of FIG. 5, the process begins with step 84, where a determination is made as to the current value of the wellness credit of interest. At decision block 86, a determination is made as to whether the wellness credit is zero. If it is, the process ends, as the credit cannot be reduced below zero.

If all or a portion of the wellness credit remains, the method continues to decision block 88, where a determination is made as to whether any employee input has been received. The employee input at issue is input relating to the decision as to whether to decrease the wellness credit. In embodiments of the invention, employee participation is required for the employees to retain their wellness credit. Therefore, if no employee input has been received, the employee's wellness credit will be reduced an applicable amount at step 90.

If, however, employee input has been received, the method continues to step 92, where the system evaluates the employee input. The evaluation is made relative to goals for the wellness program, such as goals established by the employer or by the system itself. At decision block 94, a determination is made as to whether the goals have been met based on the employee input. If yes, the method proceeds to step 96, where the current value of the wellness credit is maintained (is not reduced). It should be noted that according to embodiments of the invention, the value of the wellness credit cannot be increased, only maintained or decreased.

If the goals relating to wellbeing of the employee have not been fully met, the method instead proceeds to decision block 98, where a determination is made as to whether the goals have been partially met. If not, the value of the wellness credit is decreased at step 90 as if no employee input had been received. If, however, the goals have been partially met, the method instead proceeds to step 100, where the wellness credit is only partially decreased. For example, if the goal had been half met, the wellness credit might only be decreased half the amount that it would otherwise be decreased.

Maintaining or decreasing the value of each employee's wellness credit as illustrated in FIG. 5 may further include an additional step not illustrated in FIG. 5 of notifying a representative of the employer of information related to employees' wellbeing. A variety of information may be provided to the employer representative, such as current values of employees' wellness credits, a current sum of the values of all employees' wellness credits, a current sum of the values of a selected portion of employee's wellness credits, a current report of inputs received relating to wellbeing of the plurality of employees, information relating to employees' current health status, information relating to improvements in employees' health status, information relating to employees' current financial status, information relating to improvements in employee's financial status, information relating to employees' current activity level, information relating to improvements in employees' activity level, information relating to employees' responses to wellbeing challenges, information relating to employees' participation in a wellbeing incentivizing program, information relating to employees' participation in a portion of a wellbeing incentivizing program, and any other information relative to employees' wellness and/or changes in employees' wellness. The employer representative may use the information to implement or modify campaigns to improve employees' wellbeing, including campaigns provided through the wellness program.

Crediting virtual accounts of employees with wellness credits and then proceeding to decrease the credits to the extent employees fail to participate in the wellness program or fail to meet the goals established by the wellness program encourages employees to fully participate in the wellness program and to meet the goals and challenges provided to them by the program. Employees benefit from the wellness program by being motivated to make changes to their lives that improve wellness in a variety of areas. Meanwhile, employers benefit from the wellness program in a variety of ways including, but not limited to, decreased insurance costs, improved productivity, reduced losses to sick time and other losses of employee work, improved employee morale, and the like. Employers also benefit in that they are able to motivate and track employee wellness in real time or near real time and are able to adjust the wellness program in real time or near real time to better achieve the goals of the wellness program.

Therefore, embodiments of the invention provide both employee and employer interfaces to facilitate achievement of the purposes of the wellness program discussed herein. An employee interface may provide employees with a variety of information. For example, the employee interface may provide employees with the current value of their virtual wellness credits, as well as with the value of any accrued but not yet formally paid previous wellness credits, or even any past wellness credits achieved. The display of past wellness credits could allow employees to be aware of and compare their improvement in achieving the full wellness credit available to them, and the ability to view the current wellness credit allows employees to take action to maintain the value of their current wellness credit.

Additionally, the employee interface provides employees with opportunities to take action and provide inputs to the system that will allow employees to maintain the values of their wellness credits. For example, the employee interface may provide employees with opportunities to input information such as current health information (e.g. weight, daily exercise amounts, etc.), current nutrition information (e.g. servings of vegetables consumed recently), etc., as selected by the wellbeing program administrator and/or the employee. The employee interface program may also allow employees to select wellness goals to work on and may receive inputs from employees relative to their established goals.

The employee interface may present certain challenges to employees designed to motivate improved employee wellness. Employees may then provide inputs in response to the challenges presented to them, and those inputs may result in maintenance of their current wellness credits. In some instances, challenges may be informational in nature, such as questions relating to wellness and requiring that the employees provide a correct answer to maintain their wellness credit value. While some employees might already know some of the answers, other employees might have to better inform themselves before being able to answer the questions, and the process of informing themselves may lead to improved ability to increase their wellness through future use of the information learned. The question and response process may provide employers with essentially immediate feedback on employees understanding of wellness-related issues and/or employees' compliance with the requirements of the wellness program.

Other challenges may require action to maintain the value of employees' wellness credits. For example, the system may present employees with any of a variety of challenges requiring reporting on certain behavioral responses. By way of example only, the employees may be presented with a challenge relating to proper rest, such as to get at least 7 hours of uninterrupted sleep, to avoid distractions immediately prior to going to sleep, or the like. The employees could then report each day by a certain time as to whether they met the rest-related challenge/goal. As another example, the employees might be challenged to consume a proper number of daily servings of fruits and/or vegetables, and could report on the number of servings consumed each day.

As another example, employees could be challenged to conserve natural resources, such as by turning off air conditioning when not at home, installing and/or using a programmable thermostat, turning off lights when not in a room, shutting off the water while brushing teeth, etc. Employees could then report on their success, progress, or efforts in responding to the challenges presented to them. As another example, employees could be challenged with any of a variety of financial goals designed to improve wellness, such as goals to establish a savings account, goals to save a certain percentage of money in their savings accounts, goals to contribute a certain amount to their retirement funds, goals to pack a lunch instead of eating out, etc. As employees meet or progress toward these goals, they could report to the system through the employee interface.

As another example, employees could be challenged with goals related to their employment and/or career improvement, such as challenges to participate in a training program, challenges to improve their career networking efforts, challenges to complete work projects on time or early, challenges to establish personal work/career goals, etc. Opportunities to report and maintain the value of the employees' wellness credits could also be provided. As another example, challenges could be issued by the system through the employee interface relating to employees' social wellness, such as challenges to thank a peer for assistance, challenges to join and/or participate in a local group, etc. As always, opportunities to report on efforts to meet the challenges would be provided through the employee interface. Other examples of challenges and responses are myriad, and could include efforts to increase activity (e.g. walking, taking the stairs instead of the elevator), etc., or in any other area of interest to the particular embodiment of a wellness program.

While an employee interface has been discussed above, it should be recognized that a single unitary employee interface is not necessarily required. Indeed, an employee interface may be provided in a distributed fashion. As part of an employee interface, challenges could be issued to employees using text messages and the like. Employees could have an app on their mobile devices for them to receive and respond to challenges as part of an employee interface, and could also access an employee interface through a browser using a mobile device or any computing device, including laptop and desktop computers at home or work. Part of the employee interface may be provided, including automatically provided, by wearable or implantable devices that track information such as information relating to physical activity, heart rate, sleep quality, and the like, or any information that can now be captured by wearable or implantable devices, or that can be captured by such devices in the future. Examples of current such devices include a heart rate monitor, a GPS device, a fitness tracking device, a pedometer, a sleep quality monitor, a calories burned monitor and/or calculator, a blood oximeter, and a glucose meter. Therefore, the employee interface is not limited to a single embodiment or form, but is intended to embrace any mechanism for providing the interaction between the wellness system and the employees discussed or contemplated herein.

As the system receives information from a number of employees, it aggregates the information and makes it available to the employer or the employer's representatives, such as a wellness program administrator. Additionally and optionally, the information may be made available in whole or in part across multiple employers. The aggregation of information may be used for a variety of purposes. For example, employees might be made aware of comparisons between their own efforts and the efforts of others. Additionally, while maintaining respect for privacy, employees might be made aware of successes of other employees specifically or generally to help motivate them in their own wellness efforts.

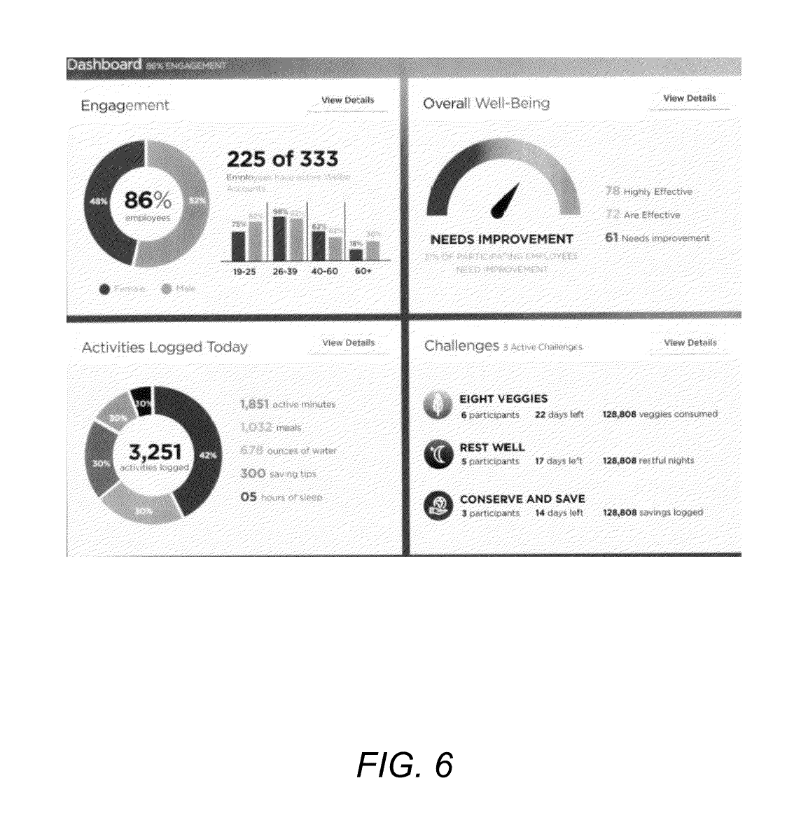

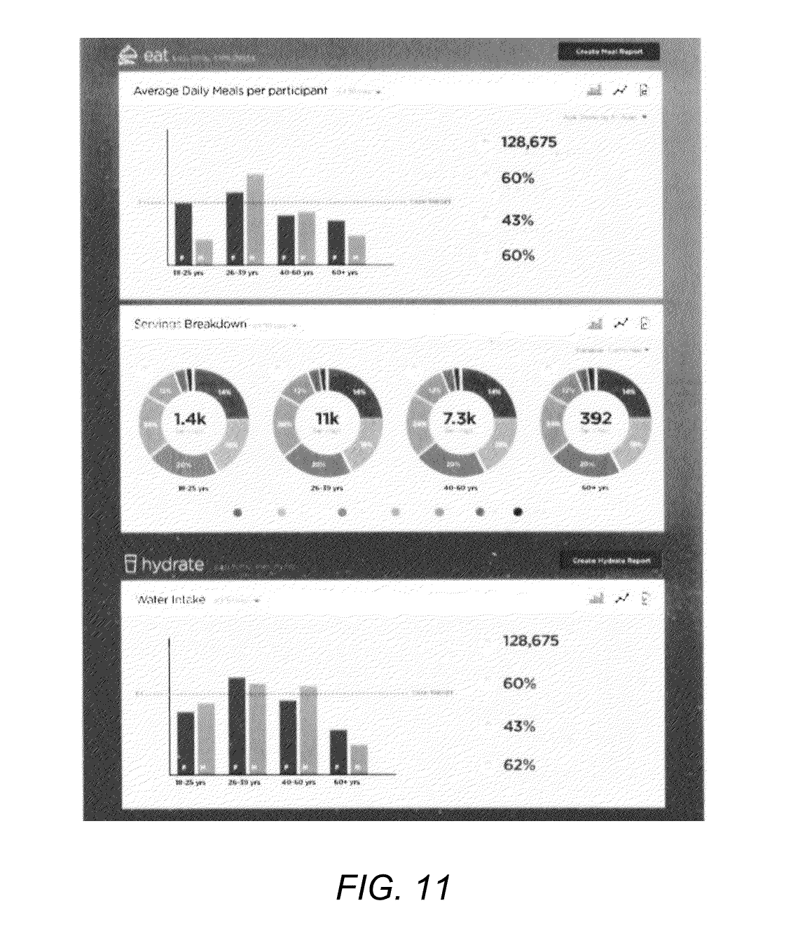

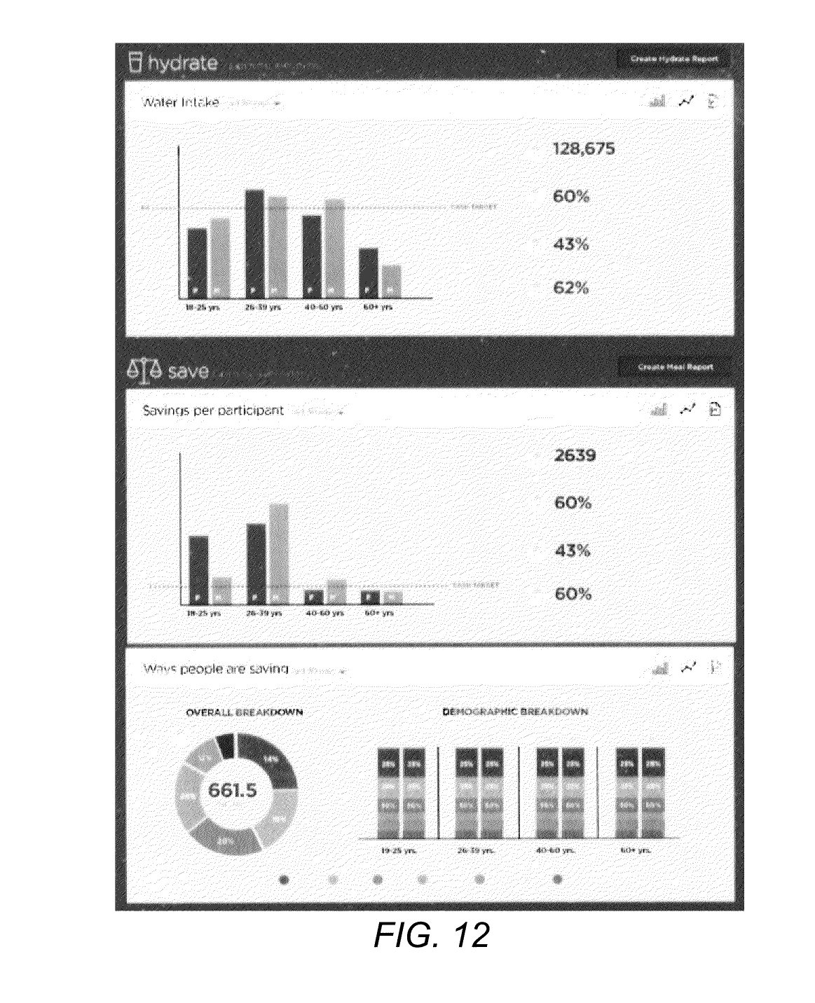

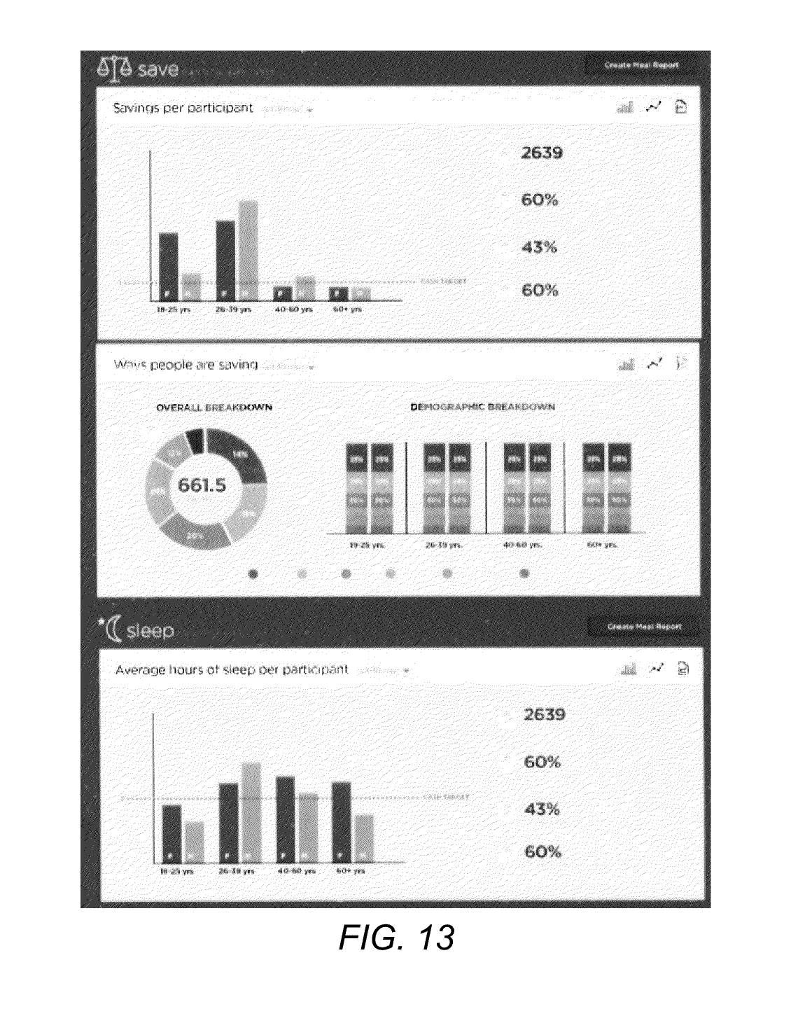

The greatest anticipated benefit, however, is the provision of real-time or near-real-time information relating to the wellness program to employers so they can monitor, track, and modify their wellness programs to best effect. To that end, the system provides an employer interface to the employer or its representatives that allows the employer to view a variety of information relating to the wellness program and the performance of employees. FIGS. 6-13 show screenshots of aspects of a representative employer interface for purposes of illustration. It will be understood that the employer interface may be designed in a variety of ways and may be modified for a variety of reasons, including functional and aesthetic reasons, so the interface shown in FIGS. 6-13 is not intended to be limiting.

The employer interface may provide information in a variety of ways, and may include a variety of screens arranged in a variety of ways (e.g. by tabs, menus, etc.). As one example, a “dashboard” view as illustrated in FIG. 6 may be provided. The dashboard view may provide summary information regarding the participation of the employees in the wellness program. By way of the specific example of FIG. 6, the dashboard view provides information regarding: (1) employees generally and their engagement with the wellness program/system (upper left quadrant), (2) activities logged with the system as part of employees inputs (lower left quadrant), (3) overall wellbeing of employees based on employees' engagement with the system and employees' inputs received by the system (upper right quadrant), and (4) employees response to existing challenges of the wellness program (lower right quadrant). The employer or its representative can use selections within the dashboard to obtain more information about these areas of information.

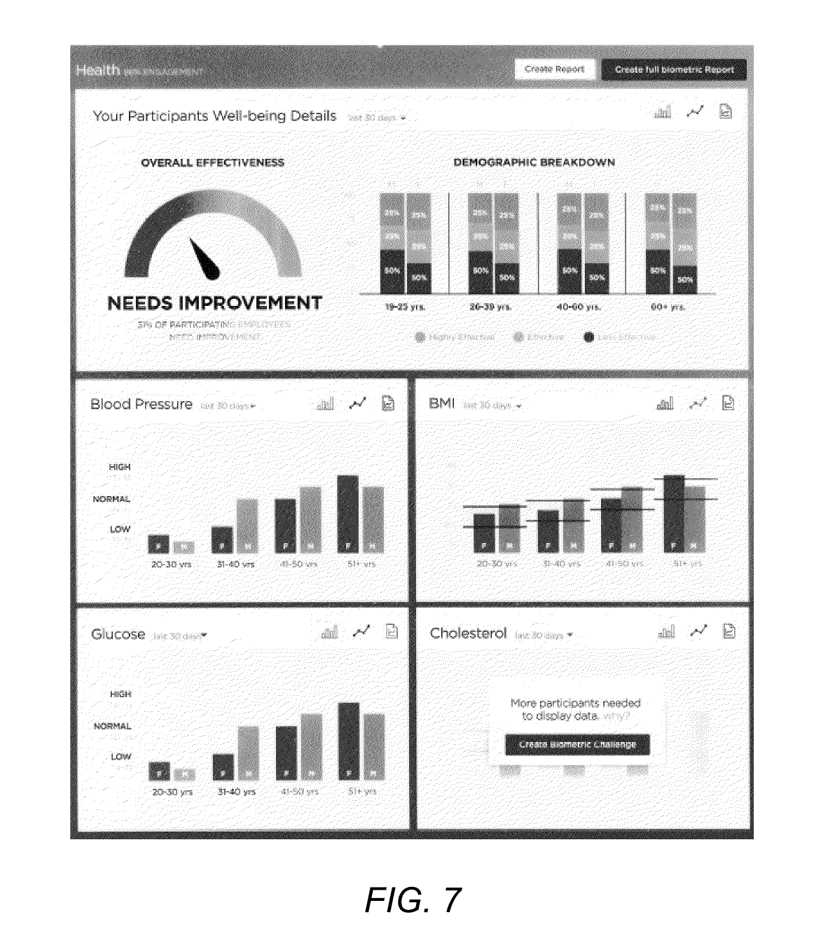

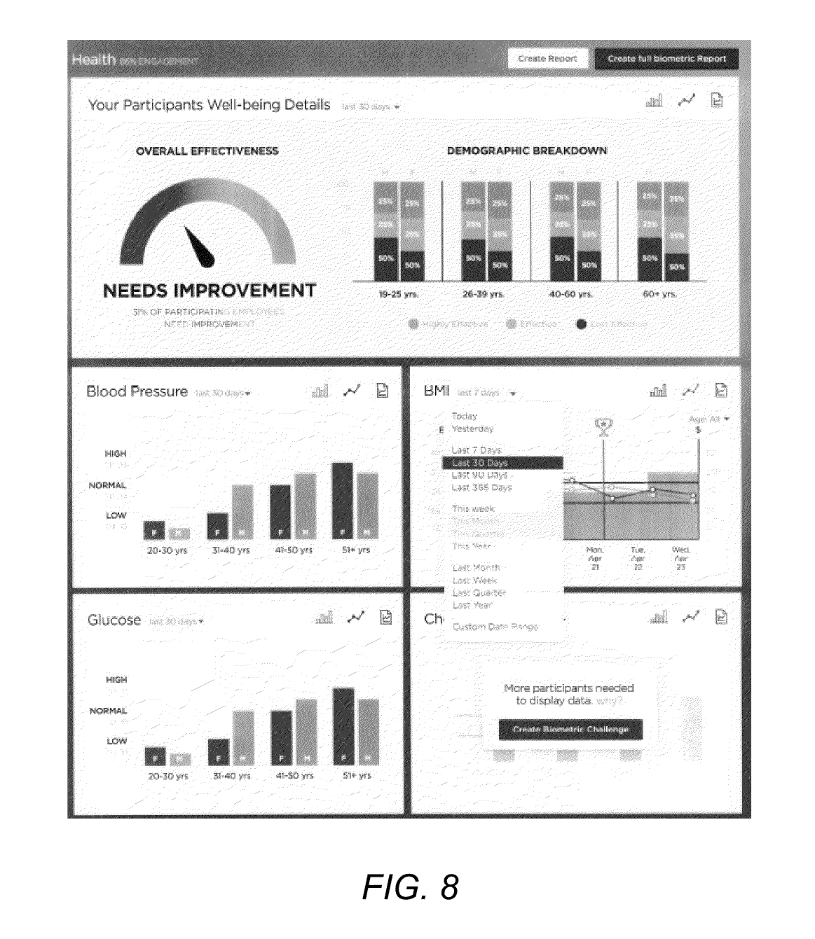

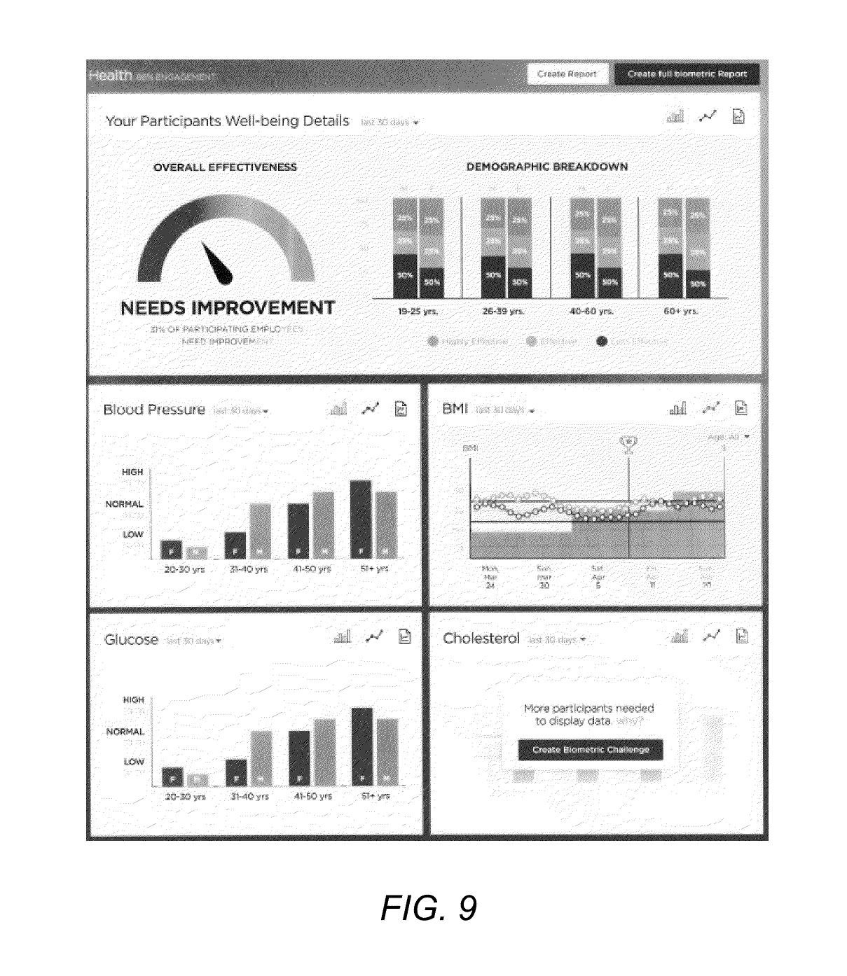

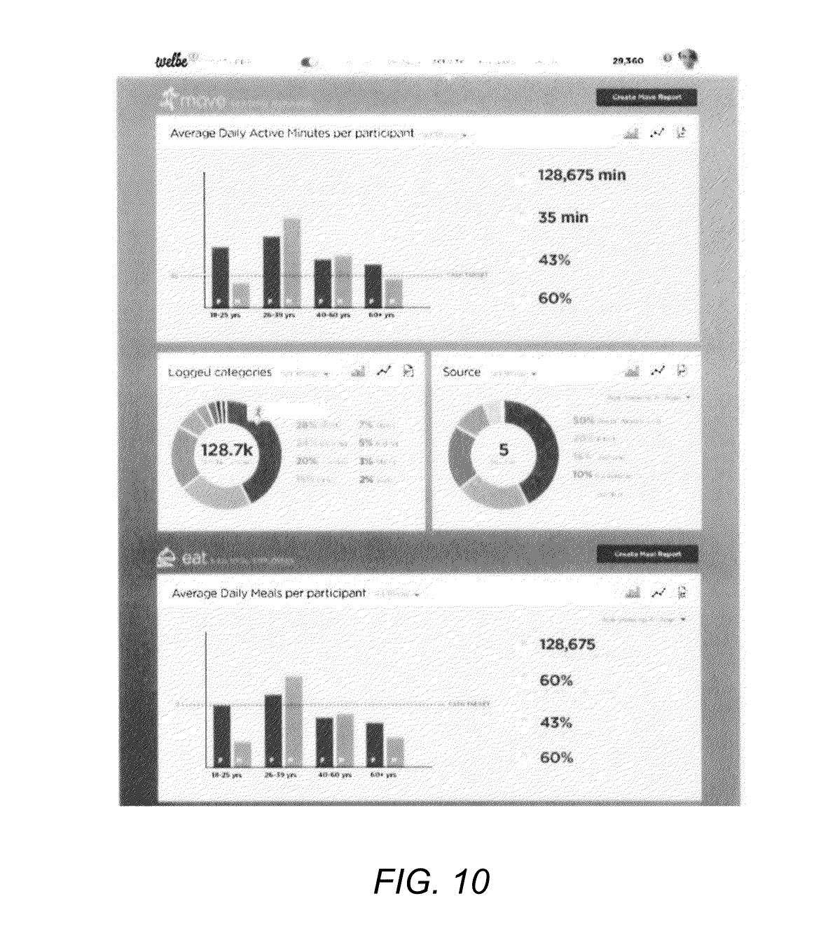

For example, an employer might be presented with a screen similar to that shown in FIG. 7 upon selecting to view more information regarding employees overall wellbeing. A variety of information might be tracked and reported, but the specific example illustrated shows general information about participants (e.g. demographics such as age and sex and overall wellness by demographics), blood pressure, BMI, glucose levels, and cholesterol levels. In some instances, options may be provided to view additional information, or to view information over different time periods. For example, as shown in FIGS. 8 and 9, the BMI information displayed could be changed to view a different date range. Additionally as also illustrated in FIGS. 7-9, the information could be displayed in different fashions, as is illustrated with different ways of displaying the BMI information in these Figures. FIGS. 10-13 show screenshots of additional information that could be displayed to the employer or its representatives.

Because the employer has access to information in real time or near real time, the employer is able to view the effectiveness of the wellness program at any time. Additionally, the employer is able to customize the wellness program to better achieve wellness goals. For example, the employer may use the system to issue a challenge intended to improve employee wellness, such as a challenge to eat a certain number of servings of vegetables per day. As the challenge progresses, the employer is able to view the challenge's effect on overall wellbeing of all employees, on specific groups of employees, or even on individual employees. If a particular challenge is having little to no effect, the employer can cancel the challenge and issue a new challenge, can modify the challenge, or can simply issue a new challenge. In this way, the wellness program can be of most effect and the system can be used to best motivate and incentivize improvements to employees' wellbeing.

Where information is shared across employers, employers can be notified of successes achieved by other employers. For example, an employer may be notified of campaigns and challenges that were deemed particularly successful in other employers' wellness efforts. Other employers could then adopt those campaigns and challenges, or modified versions thereof to their own efforts and systems. Thus, embodiments of the invention provide myriad ways in which to incentivize improved employee wellbeing, with benefits both to employees and employers.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A computer-implemented method of incentivizing behavioral changes in employees, the behavioral changes leading to improved employee wellbeing and reduced insurance rates for an employer, the method comprising computing-device-implemented steps of:
crediting a virtual account of each of a plurality of employees with a wellness credit at a start of a first time period;
maintaining or decreasing the value of each employee's wellness credit during the first time period, comprising repeated steps of:
notifying each of the plurality of employees of his or her current wellness credit;
receiving inputs during a portion of the first time period relating to wellbeing of each of the plurality of employees; and
utilizing the inputs relating to wellbeing of each of the plurality of employees to perform an action selected from the group consisting of:
maintaining a current value of that employee's wellness credit; and
deducting an amount from that employee's wellness credit;
reporting, at the end of the first time period, each employee's final wellness credit for the first time period; and
providing, at the end of a second time period, each employee with the sum of all final wellness credits for that employee during the second time period.

2. A computer-implemented method as recited in claim 1, wherein the value of each employee's wellness credit is tracked and available in real time.

3. A computer-implemented method as recited in claim 1, wherein an initial value of each employee's wellness credit corresponds to an estimated value to the employer of improved wellbeing of the employees.

4. A computer-implemented method as recited in claim 1, wherein maintaining or decreasing the value of each employee's wellness credit during the first time period further comprises an additional repeated step of:
notifying a representative of the employer of information related to employees' wellbeing, the information selected from the group consisting of:
current values of employees' wellness credits;
a current sum of the values of all employees' wellness credits;
a current sum of the values of a selected portion of employee's wellness credits;
a current report of inputs received relating to wellbeing of the plurality of employees;
information relating to employees' current health status;
information relating to improvements in employees' health status;
information relating to employees' current financial status;
information relating to improvements in employee's financial status;
information relating to employees' current activity level;
information relating to improvements in employees' activity level;
information relating to employees' responses to wellbeing challenges; and
information relating to employees' participation in a wellbeing incentivizing program.

5. A computer-implemented method as recited in claim 4, wherein maintaining or decreasing the value of each employee's wellness credit during the first time period further comprises an additional repeated step of:
receiving input from the representative of the employer to modify a campaign to improve employees' wellbeing based on the information related to the employees' wellbeing.

6. A computer-implemented method as recited in claim 4, wherein maintaining or decreasing the value of each employee's wellness credit during the first time period further comprises an additional repeated step of:
receiving input from the representative of the employer to implement a campaign to improve employees' wellbeing based on the information related to the employees' wellbeing.

7. A computer-implemented method as recited in claim 1, wherein an initial value of each employee's wellness credit corresponds to an estimated reduction in healthcare costs that the employer could realize during the first time period if the plurality of employees all had an ideal wellbeing.

8. A computer-implemented method as recited in claim 1, wherein receiving inputs during a portion of the first time period relating to wellbeing of each of the plurality of employees comprises receiving inputs from one or more wearable or implantable devices configured to monitor information related to physical wellness of one or more of the plurality of employees.

9. A computer-implemented method as recited in claim 8, wherein the one or more wearable or implantable devices comprise one or more devices selected from the group consisting of:
a heart rate monitor;
a global positioning system (GPS) device;
a fitness tracking device;
a pedometer;
a sleep quality monitor;
a calories burned monitor and/or calculator;
a blood oximeter; and
a glucose meter.

10. A computer-implemented method as recited in claim 8, wherein the inputs received from the one or more wearable or implantable devices are received in real time.

11. A computer-implemented method as recited in claim 10, wherein the inputs received from the one or more wearable or implantable devices are aggregated and provided to the employer in real time to facilitate the employer's real-time efforts to improve employee wellbeing.

12. A computer-implemented method of incentivizing behavioral changes in employees, the behavioral changes leading to improved employee wellbeing and reduced insurance rates for an employer, the method comprising computing-device-implemented steps of:
crediting a virtual account of each of a plurality of employees with a wellness credit at a start of a first time period;
maintaining or decreasing the value of each employee's wellness credit during the first time period, comprising repeated steps of:
notifying each of the plurality of employees of his or her current wellness credit;
receiving inputs during a portion of the first time period relating to wellbeing of each of the plurality of employees;
utilizing the inputs relating to wellbeing of each of the plurality of employees to perform an action selected from the group consisting of:
maintaining a current value of that employee's wellness credit; and
deducting an amount from that employee's wellness credit;
notifying a representative of the employer of information related to employees' wellbeing;
receiving input from the representative of the employer to modify one or more aspects of a campaign to improve employees' wellbeing based on the inputs received from the employees related to the employees' wellbeing;
reporting, at the end of the first time period, each employee's final wellness credit for the first time period; and
providing, at the end of a second time period, each employee with the sum of all final wellness credits for that employee during the second time period.

13. A computer-implemented method as recited in claim 12, wherein the information related to employees' wellbeing is selected from the group consisting of:
current values of employees' wellness credits;
a current sum of the values of all employees' wellness credits;
a current sum of the values of a selected portion of employee's wellness credits;
a current report of inputs received relating to wellbeing of the plurality of employees;
information relating to employees' current health status;
information relating to improvements in employees' health status;
information relating to employees' current financial status;
information relating to improvements in employee's financial status;
information relating to employees' current activity level;
information relating to improvements in employees' activity level;
information relating to employees' responses to wellbeing challenges; and
information relating to employees' participation in a wellbeing incentivizing program.

14. A computer-implemented method as recited in claim 12, wherein receiving inputs during a portion of the first time period relating to wellbeing of each of the plurality of employees comprises receiving inputs from one or more wearable or implantable devices configured to monitor information related to physical wellness of one or more of the plurality of employees.

15. A computer-implemented method as recited in claim 14, wherein the one or more wearable or implantable devices comprise one or more devices selected from the group consisting of:
a heart rate monitor;
a global positioning system (GPS) device;
a fitness tracking device;
a pedometer;
a sleep quality monitor;
a calories burned monitor and/or calculator;
a blood oximeter; and
a glucose meter.

16. A computer-implemented method as recited in claim 14, wherein the inputs received from the one or more wearable or implantable devices are received in real time.

17. A computer-implemented method as recited in claim 16, wherein the inputs received from the one or more wearable or implantable devices are aggregated and provided to the employer in real time to facilitate the employer's real-time efforts to improve employee wellbeing.

18. A computer-implemented method as recited in claim 12, wherein maintaining or decreasing the value of each employee's wellness credit during the first time period further comprises additional repeated steps of:
receiving input from the representative of the employer configured to issue a wellbeing challenge to one or more of the plurality of employees;
outputting the wellbeing challenge to the one or more of the plurality of employees; and
receiving inputs from employees relating to completion or partial completion of the wellbeing challenge.

19. A computer-implemented method as recited in claim 12, wherein maintaining or decreasing the value of each employee's wellness credit during the first time period further comprises additional repeated steps of:
receiving input from the representative of the employer configured to issue a wellbeing question to one or more of the plurality of employees;
outputting the wellbeing question to the one or more of the plurality of employees; and
receiving inputs from employees comprising responses the wellbeing question.

20. A computer-implemented method as recited in claim 12, wherein at least some portion of the inputs received from employees are anonymized prior to presenting information to the employer.
